(19) United States
(12) Patent Application Publication
(10) Pub. No.: US 2019/0171224 A1
(43) Pub. Date: Jun. 6, 2019

(54) Method and Device for Self-Positioning a Vehicle

(71) Applicant: Volkswagen Aktiengesellschaft, Wolfsburg (DE)

(72) Inventors: Frederik Meysel, Braunschweig (DE); Marc-Michael Meinecke, Sassenburg (DE)

(73) Assignee: Volkswagen Aktiengesellschaft, Wolfsburg (DE)

(21) Appl. No.: 16/204,643

(22) Filed: Nov. 29, 2018

(30) Foreign Application Priority Data
Dec. 1, 2017 (DE) 10 2017 221 691.3

(51) Int. Cl. G05D 1/02; G01S 13/89

(52) U.S. Cl. CPC G05D 1/0257; G01S 13/89; G05D 1/0088; G05D 2201/0213; G05D 1/0223

(57) ABSTRACT

In a method for self-positioning a vehicle in its environment, the environment is detected by means of an environmental sensor system, and a map is created in the first step during vehicle travel. In a second step, the environmental sensor system perceives features and compares them with the previously created map for self-positioning. In this case, the environmental sensor system is formed by a radar sensor system, wherein the radar sensor system ascertains reflection points to create the map, sorts-out nonstationary reflection points and only uses stationary reflection points, and for self-positioning the vehicle, the reflection points determined during travel are compared with those in the map in order to determine the position of the vehicle in the map.

### CROSS-REFERENCE TO RELATED APPLICATIONS

This application claims priority to German Patent Application No. 10 2017 221 691.3, filed on Dec. 1, 2017 with the German Patent and Trademark Office, the contents of which application are hereby incorporated by reference in their entireties.

### TECHNICAL FIELD

The invention relates to a method for self-positioning a vehicle in its environment, as well as a corresponding method.

Various driver assistance and automation systems, including systems for vehicles for automatic driving, have already been introduced on the market or are in a state of research or development. In many of the systems, the precise positioning of the vehicle plays a decisive role. Consequently, positioning algorithms are increasingly required that adequately address this need.

In this context, two basic types of vehicle positioning are of interest:
on the one hand, vehicle self-positioning with respect to a spatial, local section, as is the case for example when parking in a parking space, and
on the other hand, self-positioning a vehicle with respect to global coordinates, or with respect to a global map.

In the two aforementioned instances, positioning approaches are suitable in which two steps are used.

In a first step, the environment is detected by means of an environmental sensor system during vehicle travel, and a map is created that contains environmental features used for positioning. This can be image content for visual methods that are easily recognizable. In the case of ultrasound or lidar-based methods, this would be points in space that return the transmitted signal, i.e., reflection points.

Independent of the sensor system used and with the assistance of movement measurements or a reference system, a map is created in a first step in which the recognized features are registered at the spatially correct locations.

In a second step, the sensor system perceives features and compares them with the previously created map. By using algorithms for determining the best correspondence between currently measured features and sections of the map, the position and orientation of the observer is determined as the best solution.

A disadvantage of the known methods is that weather influences and changing light conditions strongly distort measurements based on cameras, or even render them impossible. Measurements using ultrasound have a very short range, as is known. Lidar-measurements rely on favorable visibility conditions and can be distorted by the effect of sun or fog.

The document DE 10 2007 061 235 A1 relates to a method for classifying distance data from a distance detection system and a corresponding distance measuring device. By means of the method, the height of the objects can be classified, relative to which the distance can be measured. The classification is achieved by a correlation of the statistical spread with an object height.

The document DE 10 2013 015 892 B4 relates to a device and a method for positioning by a vehicle on or above a planetary surfaces. The proposed device comprises a first means for determining a first position P1(t) of the vehicle, a second means for determining a movement direction BR(t) of the vehicle, a third means for providing a number n of the fixed point data, wherein the fixed point data indicate the radar signature RSFROi and the position PFROi at least for significant radar objects FROi fixedly arranged on the planet surface, with i=1, 2, . . . n, a radar system with a radar sensor arranged on the vehicle for scanning a current environment of the vehicle by means of radar waves and for continuously detecting radar data obtained thereby, wherein the radar signature RSk(t) and the positions LlPOk(t) relative to the vehicle can be determined from the radar data for a plurality m of radar objects ROk(t) in the environment, with k=0, 1, 2, . . . , m, and wherein the radar system is designed and configured to determine a second position P2(t), and the first means is designed and configured such that the first position P1(t) of the vehicle can the corrected based on the determined second position P2(t), and/or a position warning can be output when the first position P1(t) and the second position P2(t) deviate from each other by more than a given limit value.

The document DE 10 2011 119 762 A1 provides a positioning system suitable for a motor vehicle, and a corresponding method. The system comprises a digital map in which data are registered as located by site-specific features, at least one environment recognition device for detecting the site-specific features in the environment of the vehicle, and a positioning module coupled to the digital map and the environment recognition device. The positioning module has a processing unit for comparing the detected data and the data on the site-specific features registered in the digital map, and for positioning the vehicle position using the site-specific features registered located in the digital map. Furthermore, the system comprises an inertial measuring unit of the vehicle for vehicle movement data that is coupled to the positioning module, the processing unit of which is configured to determine the vehicle position by means of the vehicle movement data based on the position located by the site-specific features.

### SUMMARY

To control an automatically driving vehicle or for modern safety and assistance functions, it is moreover not just the current positions that are of great interest, but also their derivations over time, i.e., the speeds as well as changes in position and alignment, such as the rotational speed about the vertical axis (yaw rate).

These are particularly important for many applications since automatic control and safety functions refer to these values or even their derivations (i.e., accelerations), and not for example to the static measurements.

These speed measurements can be determined using conventional methods only with the assistance of additional inertial sensors, and from the other sensors only indirectly by calculating from changes in measured values.

An underlying object thus exists to render self-positioning, including determining movement quantities, of a vehicle more independent from disturbing environmental influences.

This object is solved by a method for self-positioning a vehicle having the features of the independent method claim, as well as by a corresponding device having the features of the independent apparatus. Some embodiments are the subject of the dependent claims.

### BRIEF DESCRIPTION OF THE DRAWINGS

The invention is explained in the following using exemplary embodiments. The drawings show in

FIG. 1 a parking process based on self-positioning in a tight local environment;

FIG. 2 the positioning of a vehicle with respect to a global map;

FIG. 3 a vehicle equipped with a radar sensor for self-positioning;

FIG. 4 an example of a configuration of radar reflection points; and

FIG. 5 the device for self-positioning the vehicle in a schematic representation.

In the present aspect for self-positioning a vehicle in its environment, the environment is detected by means of an environmental sensor system, and a map is created in the first step during vehicle travel. In a second step, the environmental sensor system perceives features and compares them with the previously created map for self-positioning. In this case, the environmental sensor system is formed by a radar sensor system, wherein the radar sensor system ascertains reflection points to create the map, sorts-out nonstationary reflection points and only uses stationary reflection points, and for self-positioning the vehicle, the reflection points determined during travel are compared with those in the map in order to determine the position of the vehicle in the map.

A benefit of self-positioning the vehicle of the current aspect is based on high-performance radar sensors that in some embodiments function in the microwave frequency band are that self-positioning is independent of weather conditions, light incidence, fog, snow, rain and/or the development of dust.

In addition to self-positioning the vehicle and in some embodiments, an estimation of the self-movement of the vehicle is provided. This estimation of the self-movement is also independent of the external conditions such as weather, light, fog, rain, snow or dust development.

In some embodiments, it is provided to detect the self-movement of the vehicle by measuring the direct radial speed of the reflection points. Measuring the environment in different viewing directions proves to be a very special benefit of microwave-based positioning in this case. By directly measuring the relative radial speeds of the reflection points to the observer and in some embodiments, the self-movement can be reliably determined and even plausiblized.

In some embodiments, the self-movement of the vehicle to comprise at least its speed and acceleration. Robust self-positioning therefore enables direct speed measurements and their derivations relative to the environment.

Furthermore and in some embodiments, the rotation of the vehicle is determined from different relative speeds of the reflection points in viewing directions that differ from each other, wherein in particular the yaw rate can in some embodiments be determined from the rotation of the vehicle. It is known that the systems known from the prior art are particularly susceptible to error during rotational movements and cornering. Radar-based feature measurements contrastingly have a particular impact. If different relative speeds are detected uniformly in the environment of the observer in different viewing directions, the resulting rotation and hence the yaw rate therefrom can be calculated.

In another aspect, a device according for self-positioning a vehicle in its environment is provided, wherein the device is designed and configured to perform a method according to one or more of the preceding embodiments. The device comprises:
an environmental sensor system for detecting the environment of the vehicle during travel,
an apparatus for creating a map of the detected environment, and
an apparatus for determining the position of the vehicle based on the map and the data from the environmental sensor system. In some embodiments, the environmental sensor system is formed by a radar sensor system that determines stationary reflection points. In some embodiments, the map consisting of the determined stationary reflection points is created by the apparatus for creating the map of the environment. In some embodiments, the reflection points determined during travel are compared with those of the map from the apparatus for determining the position of the vehicle in order to determine the position of the vehicle in the map.

In some embodiments, the device may have an apparatus to determine the self-movement of the vehicle from the reflection points ascertained during travel.

Rotational movements of the vehicle in some embodiments may be determined by the apparatus for determining the self-movement of the vehicle.

Benefits of the radar measurements for self-positioning a vehicle of some embodiments may be as follows:
independence of the measurement of estimated self-movement from weather conditions, incident light, fog or dust development;
very precise estimated self-movements result due to the typical given precise resolution (and also precision) of radar measurement with respect to the target distance and target speed;
due to the high probability of recognizing stationary object reflection centers (even under poor weather conditions), the method is highly suitable for robustly positioning in a previously recorded map; and
the speed and yaw rates of the vehicle can even be determined and plausiblized by measurements in different directions with an individual sensor.

Further embodiments of the aforementioned aspects are explained in greater detail below with reference to the drawings.

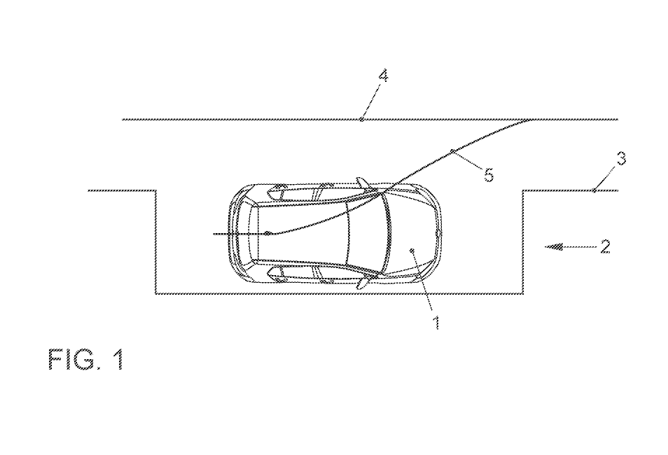

FIG. 1 shows local self-positioning of a vehicle 1 in an embodiment of an automated or assisted parking process in a parking space 2 which is symbolized here by a boundary 3. During passage 4 along the parking space 2, an environmental sensor system (not shown) of the vehicle 1 detects the beginning, the length, the depth and the end of the parking space 2 relative to the vehicle 1. Based on this self-positioning of the vehicle, the parking system calculates a parking trajectory 5 along which the vehicle 1 parks in the parking space 2.

In other words, an environmental map, i.e., the parking space 2, is created from the data from the environmental sensor system. During the parking process along the parking trajectory 5, the map created during passage 4 is compared with current environmental measurements in order to be able to determine the current location of the vehicle 1 along the trajectory 5.

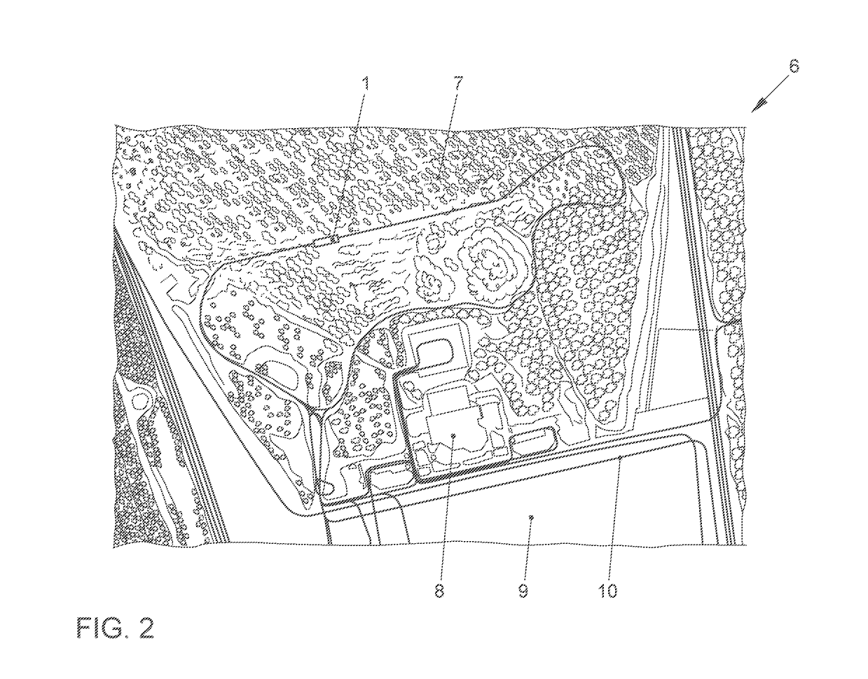

FIG. 2 shows the self-positioning of a vehicle with respect to global coordinates, or with respect to a global map. The vehicle 1 moves in an environment 6 such as a testing ground comprising a forest region 7 with a building structure 8 and a free surface 9 provided with a surface. In this environment 6, the vehicle 1 has moved along the trajectories 10 drawn in FIG. 2 and created a map by means of an environmental sensor system so that the current position of the vehicle 1 in the forest region 7 can be determined in a second step by a comparison of current features of the environmental sensor system with the created map.

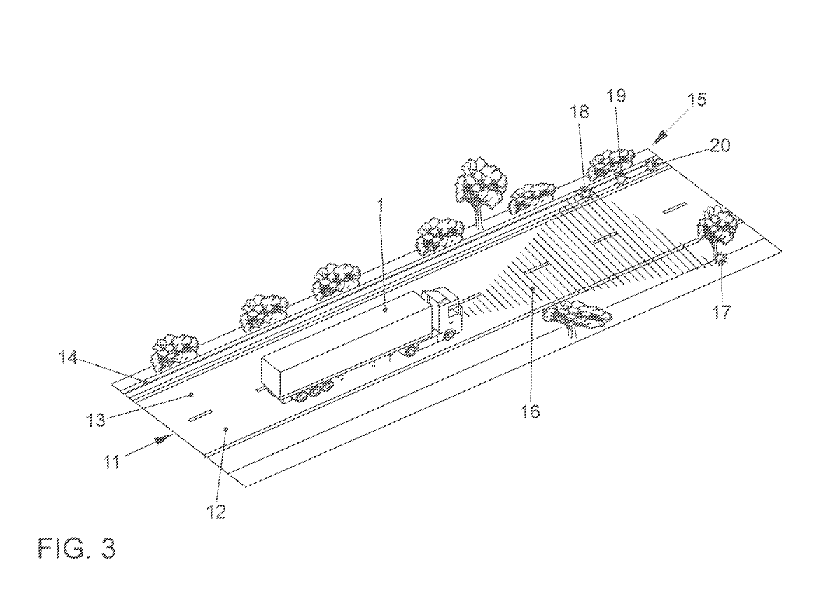

FIG. 3 shows the use of the radar sensor system as a positioning sensor. Both the positioning map in the first step as well as the actual measurement for positioning the vehicle are realized in this embodiment by microwave-based radar measurements. In the exemplary embodiment, the vehicle 1, in this case in the form of a truck, moves on a two-lane road 11 that is part of a highway, wherein the road 11 has a right lane 12 and a left lane 13, and the two-lane road 11 has a guardrail system 14 on the median strip 15 for delimitation to the left of the left lane 13.

In this context, one or more radar sensors (not shown) are installed on the vehicle 1 with a field of vision 16 that is schematically portrayed toward the front in the direction of travel. There are a plurality of reflection points 17, 18, 19, 20 in this field of vision 16 at the edge of the road 11 that are stable from observation to observation and can be re-found with great probability. Since these reflection points 17 to 20 can be rediscovered and their position does not change over time with great probability, a map can be created with the assistance of the reflection points 17 to 20 that are suitable for self-positioning the vehicle 1.

A special feature of radar measurements is already exploited in the creation of the map from the reflection points 17 to 20. Since speeds are also directly derivable from these measurements, nonstationary objects can already be ascertained and sorted out in this step, and are therefore not included in the environmental map for self-positioning.

Since the reflection points 17 to 20 are therefore stationary, they can be used in the second step for self-positioning. Initially by measuring a plurality of reflection points 17 to 20, a comparison with the map can be made, and the position of the vehicle on the map can be determined. The more reflection points 17 to 20 of stationary objects can be clearly rediscovered from measurement to measurement, the more precise the self-movement estimation also becomes within this interval in time. In addition, the precision of the self-movement estimation is also dependent on the position of the measurement per se. The self-movement estimation for the observed interval in time ΔT yields a vector with the elements (Δx, Δy, Δφ)^{T}, wherein as usual, the x-axis points in the direction of travel, the y-axis is arranged perpendicular thereto, and φ is the azimuth of an object relative to the x-axis.

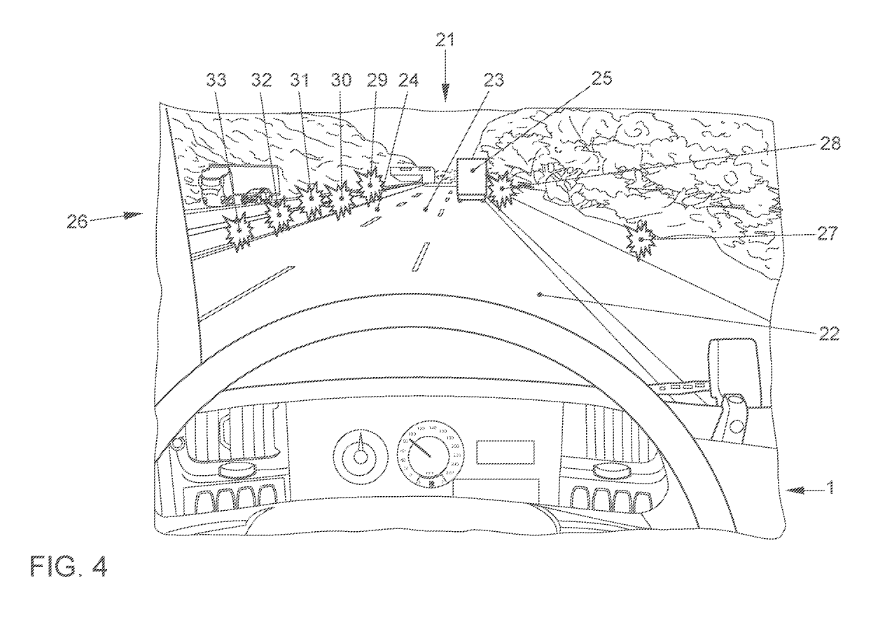

FIG. 4 shows an embodiment of a recorded reflection point map in a highway scenario, wherein FIG. 4 shows the view forward from a vehicle 1. In this context, the vehicle 1 moves on a road 21 of a highway with a right lane 22, a middle lane 23 and a left lane 24. A truck 25 is traveling on the same right lane 22 in front of the vehicle 1. Furthermore, the oncoming traffic 26 on the adjacent road is discernible in FIG. 4. Stationary objects such as trees, characteristic points on the ground, lamps, guardrail posts, manhole covers, etc. remain at the same location for very long times and are therefore used for self-positioning. FIG. 4 shows such stationary objects as reflection points 27 to 33.

Measuring the environment in different viewing directions proves to be a very special advantage of microwave-based positioning. By directly measuring the relative radial speeds of the reflection points 27 to 33 to the observer, i.e., the radar apparatus of the vehicle 1, the self-movement of the vehicle can be reliably ascertained in addition to the self-positioning, and can even be plausiblized.

If individual reflection points 27 to 33 appear to deviate from their group in terms of their relative speeds, they can be recognize as nonstationary objects and rejected.

The systems known from the prior art are particularly susceptible to error during rotational movements and cornering. Radar-based feature measurements in this case have a particular impact: If different relative speeds are detected uniformly in the environment of the observer in different viewing directions, the resulting self-movement such as a rotation can be calculated therefrom.

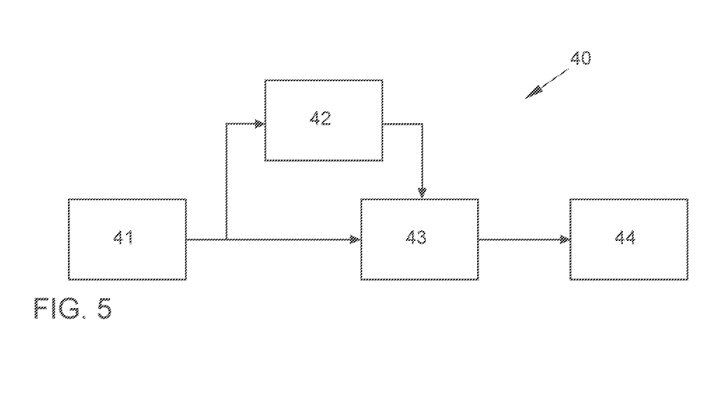

FIG. 5 shows the device 40 for self-positioning a vehicle in a schematic representation. The self-positioning device 40 comprises a radar sensor system 41 with at least one radar sensor that works within the microwave length range. In the radar sensor system 41, reflected signals are separated into signals which are assigned to stationary and nonstationary objects, and are designated as reflection points. The signals of stationary objects form the stationary reflection points which are used in the map apparatus 42 for creating maps of the vehicle environment. Currently measured stationary reflection points are supplied to an apparatus 43 for determining the position of the vehicle which compares these signals with the map of the map apparatus 42 in order to determine the position of the vehicle in the map. In a downstream apparatus 44 for the determination of the self-movement, the self-movement of the vehicle is determined using the current and previous reflection points, wherein the position of the vehicle can be included in the determination.

### REFERENCE NUMBER LIST

1 Vehicle
2 Parking space
3 Parking space boundary
4 Passage
5 Parking trajectory
6 Environment
7 Forest region
8 Building structure
9 Free area
10 Recorded driving trajectories
11 Road
12 Right lane
13 Left lane
14 Guardrail system
15 Median strip
16 Range of vision
17 Reflection point
18 Reflection point
19 Reflection point
20 Reflection point
21 Road
22 Right lane
23 Middle lane
24 Left lane
25 Truck driving ahead
26 Oncoming traffic on the oncoming road
27 Reflection point
28 Reflection point
29 Reflection point
30 Reflection point
31 Reflection point
32 Reflection point
33 Reflection point
40 Device for self-positioning
41 Radar sensor system
42 Apparatus for creating a map
43 Apparatus for determining the position of the vehicle
44 Apparatus for determining self-movement

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The mere fact that certain measures are recited in mutually different dependent claims or embodiments does not indicate that a combination of these measured cannot be used to advantage. Any reference signs in the claims should not be construed as limiting the scope.

What is claimed is:

1. A method for self-positioning a vehicle in its environment, wherein:
in a first step, the environment is detected by means of an environmental sensor system during vehicle travel, and a map is created; and
in a second step, the environmental sensor system perceives features and compares them with the previously created map for self-positioning; wherein
the environmental sensor system is formed by a radar sensor system, wherein the radar sensor system ascertains reflection points to create a map, nonstationary reflection points are sorted out and only stationary reflection points are used to create the map; and
for self-positioning the vehicle, the reflection points determined during travel are compared with those of the map in order to determine the position of the vehicle on the map.

2. The method according to claim 1, wherein there is an estimation of self-movement by the vehicle in addition to self-positioning.

3. The method according to claim 2, wherein the self-movement of the vehicle is detected by measuring the direct radial speed of the reflection points.

4. The method according to claim 3, wherein the self-movement of the vehicle comprises at least its speed and acceleration.

5. The method according to claim 2, wherein the rotation of the vehicle is determined from different relative speeds of the reflection points in viewing directions that differ from each other.

6. The method according to claim 5, wherein the yaw rate is determined from the rotation of the vehicle.

7. A device for self-positioning a vehicle in its environment, wherein the device is configured to perform the method according to claim 1, the device having:
an environmental sensor system for detecting the environment of the vehicle during travel;
an apparatus for creating a map of the detected environment; and
an apparatus for determining the position of the vehicle based on the map and the data from the environmental sensor system;
wherein
the environmental sensor system is formed by a radar sensor system, wherein the radar sensor system determines stationary reflection points;
the map comprising the determined stationary reflection points is created by the apparatus for creating the map of the environment; and
the reflection points determined during travel are compared with those of the map from the apparatus for determining the position of the vehicle in order to determine the position of the vehicle on the map.

8. The device according to claim 7, wherein the device has an apparatus to determine the self-movement of the vehicle from the reflection points ascertained during travel.

9. The device according to claim 8, wherein rotational movements of the vehicle are determined by the apparatus for determining the self-movement of the vehicle.

10. The method according to claim 3, wherein the rotation of the vehicle is determined from different relative speeds of the reflection points in viewing directions that differ from each other.

11. The method according to claim 4, wherein the rotation of the vehicle is determined from different relative speeds of the reflection points in viewing directions that differ from each other.
